(19) United States
(12) Patent Application Publication
(10) Pub. No.: US 2012/0102389 A1
(43) Pub. Date: Apr. 26, 2012

(54) METHOD AND SYSTEM FOR RENDERING WEB CONTENT

(75) Inventors: Amit Gattani, Roseville, CA (US); Aditya Agrawal, Cupertino, CA (US); Arun Kalmanje, Sunnyvale, CA (US)

(73) Assignee: Woxi Media, Sunnyvale, CA (US)

(21) Appl. No.: 13/281,093

(22) Filed: Oct. 25, 2011

Related U.S. Application Data
(60) Provisional application No. 61/455,611, filed on Oct. 25, 2010.

(51) Int. Cl. G06F 17/00

(52) U.S. Cl. 715/234

(57) ABSTRACT

A method and system for rendering web content on an end device is disclosed. An encoding server parses the web content to determine a plurality of markup tags in a native markup language associated with the web content. On determining the plurality of markup tags in the native markup language, the encoding server encodes the plurality of markup tags using a rendering markup language to form one or more packages. The rendering markup language defines a set of markup tags in the rendering markup language for each package based on the capabilities and configurations of the end device. The one or more packages are then decoded by a thin client by interpreting the set of markup tags in the rendering markup language. Since the thin client only decodes the set of tags in the rendering markup language, processing power required at the thin client is significantly reduced.

### CLAIM TO PRIORITY

This patent application claims priority to U.S. Provisional Application No. 61/455,611, filed on Oct. 25, 2010, the contents of which are hereby incorporated by reference into this application as if set forth herein in full.

### FIELD OF THE INVENTION

The invention generally relates to rendering web content, and more specifically, to a method and system for encoding the web content into one or more packages and displaying these packages on an end device based on the characteristics of the end device.

### BACKGROUND OF THE INVENTION

Web content is usually designed keeping in mind the end devices that typically display the web content. Most current computers that display web content have high resolution monitors and are primarily lean-forward displays that allow a user to lean forward and view the monitor from a close distance. The high resolution of these end device displays allows a substantially large amount of web content to be presented on a single web page. For example, a single web page may display textual content, flash content, multimedia content, etc. As a result of the high resolution of current computer monitors, web content may be rendered in a smaller size and still be viewed clearly by a user of the end device.

However, when the web content designed for high resolution monitors are to be viewed on low resolution screens, the usability and legibility of the web content on these low resolution screens is degraded. For example, if the web content is to be viewed on a television screen, the vast differences in display properties and resolutions between traditional computer monitors and the television screen makes the web content displayed on the television screen illegible. Similarly, when the web content is to be viewed on handheld devices such as mobile phones, Personal Digital Assistants (PDAs) or tablets, the resolution and the size of the displays associated with these devices make the web content illegible.

Thus, there is a need for a method and system for dynamically modifying web content to suit the characteristics of an end device on which the web content is to be rendered.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an exemplary representation of an environment in which various embodiments of the invention may function.

FIG. 2 illustrates a block diagram of a system for rendering web content on an end device in accordance with an embodiment of the invention.

FIG. 3 illustrates a data flow diagram of a system for rendering web content on an end device in accordance with an embodiment of the invention.

FIG. 4 illustrates a flow diagram of a method of rendering web content in accordance with an embodiment of the invention.

FIG. 5 illustrates a flow diagram of a method of encoding a plurality of markup tags into one or more packages in accordance with an embodiment of the invention.

FIG. 6 illustrates an exemplary web page encoded to be rendered on an end device in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components related to method and system for rendering web content. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, or apparatus that comprises a list of elements does not include only those elements but may include other elements not expressly listed or inherent to such process, method, or apparatus. An element proceeded by “comprises . . . a” does not, without more constraints, preclude the existence of additional identical elements in the process, method, or apparatus that comprises the element.

It will be appreciated that embodiments of the invention described herein may be comprised of one or more conventional transaction-clients and unique stored program instructions that control the one or more transaction-clients to implement, in conjunction with certain non-transaction-client circuits, some, most, or all of the functions of a method for rendering web content. The non-transaction-client circuits may include, but are not limited to, a radio receiver, a radio transmitter, signal drivers, clock circuits, power source circuits, and user input devices. As such, these functions may be interpreted as steps of methods for rendering web content. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to various embodiments, the invention provides a method and system for rendering web content on an end device. The method and system involves parsing the web content to determine a plurality of markup tags in a native markup language associated with the web content. On determining the plurality of markup tags in the native markup language, the plurality of markup tags are encoded using a rendering markup language to form one or more packages. The rendering markup language defines rendering properties associated with the one or more packages. Thereafter, the one or more packages are decoded using the rendering markup language to render the one or more packages based on the rendering properties.

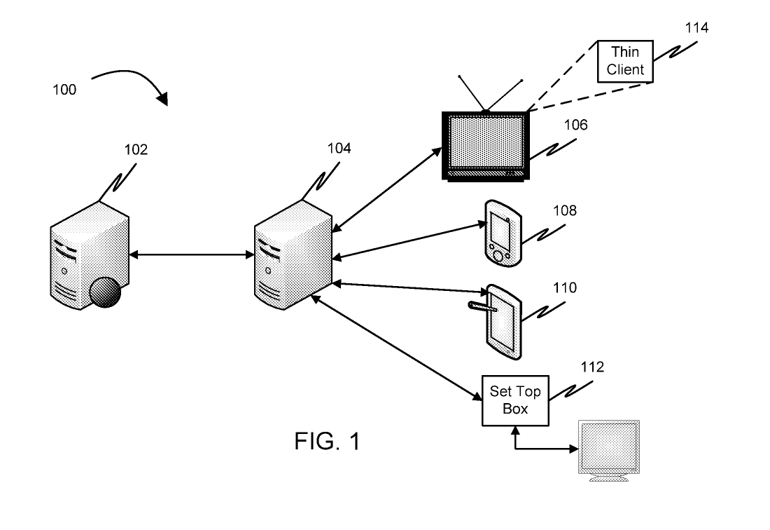

FIG. 1 illustrates an exemplary representation of an environment 100 in which various embodiments of the invention may function. Environment 100 includes a web server 102, an encoding server 104, and one or more end devices such as an end device 106, an end device 108, an end device 110, and an end device 112. Web server 102 and encoding server 104 and each of the one or more end devices are communicatively connected to each other over a network such as the Internet. In an embodiment, encoding server 104 may be hosted on a cloud. The one or more end devices may include, but are not limited to, television sets, Personal Digital Assistants (PDAs), tablet computers, a set top box connected to a television screen, and mobile phones. Further, each of the end devices include a thin client such as, a thin client 114 associated with end device 106. For the purposes of convenience of illustration, FIG. 1 only illustrates thin client 114 associated with end device 106 but it should be understood that end device 108, end device 110, and end device 112 each include a thin client.

Thin client 114 enables end device 106 to request the web content from web server 102. For example, end device 106 may request for the web content by making a Hypertext Transfer Protocol (HTTP) request to web server 102 via encoding server 104. Web server 102 processes the HTTP request and accordingly responds with the requested web content. Web server 102 may be configured to provide the web content in one of Hypertext Markup Language (HTML), Extensible Hypertext Markup Language (XHTML), Extensible Markup Language (XML), Real Simple Syndication (RSS), and JavaScript Object Notation (JSON) languages or any other mark up languages known in the art.

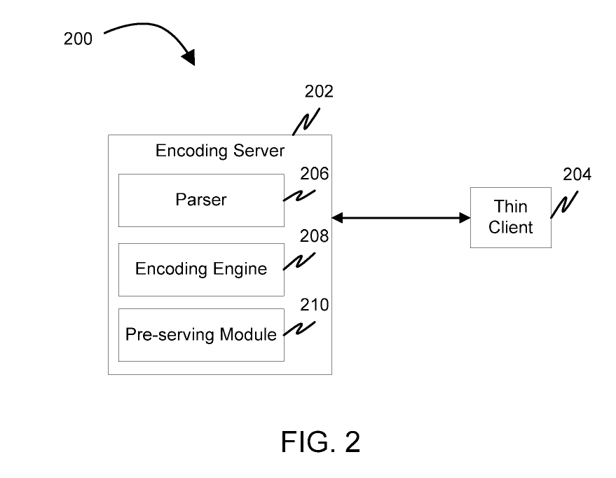

The web content provided by web server 102 in response to the HTTP request from end device 106 is intercepted by encoding server 104 and encoded to be rendered on end device 106 based on the capabilities associated with end device 106. Here, thin client 114 decodes the encoded web content prior to rendering on end device 106. Encoding the web content to be rendered on the one or more end devices based on the capabilities associated with the one or more end devices is further explained in detail in conjunction with FIG. 2.

FIG. 2 illustrates a block diagram of a system 200 for rendering web content on an end device in accordance with an embodiment of the invention. The web content may include, but is not limited to, webpages and web feeds. System 200 includes an encoding server 202 and a thin client 204. Thin client 204 is associated with the end device and is remote to encoding server 202. Encoding server 202 encodes the web content based on capabilities of an end device on which the web content is to be rendered. In an embodiment, encoding server 202 may dynamically retrieve the web content from one or more web servers, encode the web content on-the-fly and serve the encoded web content to the end device. Alternatively, encoding server 202 may retrieve the web content from the one or more web servers, encode the web content and save the web content on encoding server 202. On receiving a request for the web content from the end device, the encoded web content may be provided to the end device by encoding server 202. For example, if a user using an end device requests for a web page, encoding server 202 receives the requested web page from a web server, dynamically encodes the web page and presents the web page to the end device. In another example, if a user subscribes to one or more web feeds, these web feeds may be retrieved by encoding server 202, encoded and saved in encoding server 202. Thereafter, when encoding server 202 receives a request from the user, the one or more web feeds may be rendered on the end device of the user.

Encoding server 202 includes a parser 206 for parsing the web content to determine a plurality of markup tags associated with the web content. Encoding server 202 may receive the web content in a native markup language from the one or more web servers that host the web content. Accordingly, parser 206 parses the web content to determine the plurality of markup tags in the native markup language. The native markup language may include, but is not limited to, Hypertext Markup Language (HTML), Extensible Hypertext Markup Language (XHTML), Extensible Markup Language (XML), Real Simple Syndication (RSS) and JavaScript Object Notation (JSON) languages.

Parser 206 visually and semantically parses the web content. In an embodiment, parser 206 may parse the web content by parsing the markup tags and the corresponding Cascading Style Sheets (CSS) associated with the markup tags. The CSS describes the presentation semantics of the web content. On determining the plurality of markup tags in the native markup language, parser 206 further determines one or more of text content, multimedia content, user interaction elements, and navigational elements associated with the web content based on the markup tags in the native markup language. In other words, parser 206 separates out the text content, the multimedia content, the user interaction elements, and the navigational elements associated with the web content. Further, parser 206 may be configured to break a frame structure associated with a web page to separate out the frames associated with the web page. For example, if a web page includes three frames adjacent to each other, parser 206 may break the structure to separate out each frame to get three independent frames.

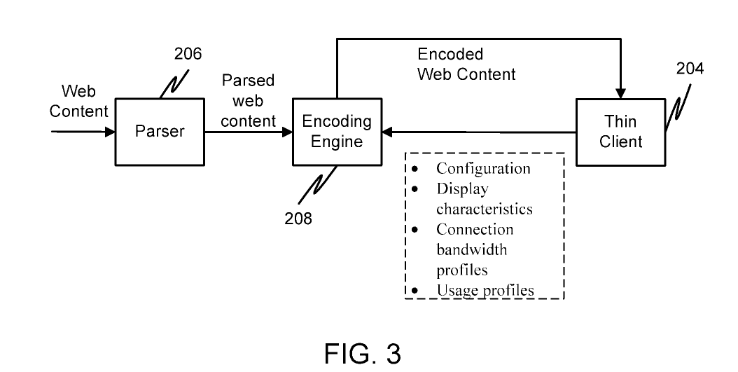

On parsing the web content to determine the markup tags associated with the web content, an encoding engine 208 associated with encoding server 202 encodes the plurality of markup tags in the native markup language into one or more packages using a rendering markup language. This is illustrated in FIG. 3 wherein, the parsed web content from parser 206 is input to encoding engine 208. Encoding the plurality of markup tags into the one or more packages involves initially creating the one or more packages and then encoding the one or more packages using the rendering markup language. In an embodiment, encoding engine 208 may create a package by grouping a number of markup tags from the plurality of markup tags in the native markup language and then interpreting these markup tags. Interpreting these markup tags in the native markup language involves decoding the markup tags using the native markup language. Once the markup tags in the native markup language associated with the package is interpreted, the package may be considered as a visual building block. In an embodiment, a visual building block may correspond to a portion of a web page. By creating and interpreting the one or more packages, the web content is broken down into one or more visual building blocks. Therefore, the number of markup tags needed to represent complete information in the rendering markup language is significantly reduced. The one or more packages are transmitted to thin client 204 and rebuilt at thin client 204 as will be explained later.

In an exemplary embodiment, a package may be created by grouping all markup tags in the native markup language that corresponds to text content of a web page. In another example, a package may be created by grouping markup tags corresponding to a frame of a web page. All the markup tags corresponding to the frame may collectively be considered as a visual building block after interpreting the markup tags in the native markup language by encoding engine 208 at encoding server 202. It may be noted that a package may also be created based on any combination of elements of a web page by grouping the corresponding markup tags. For example, an image and textual content may be combined into a single package by grouping the markup tags corresponding to the image and the markup tags corresponding to the textual content and interpreting this group of markup tags using the native markup language. The markup tags in the native markup language which constitute a package need not be interpreted by thin client 204 when the package is transmitted by encoding server 202 to thin client 204.

Once the one or more packages are created, encoding engine 208 encodes the one or more packages using the rendering markup language. The rendering markup language may be a graphical markup language and defines rendering properties for the one or more packages. Encoding the one or more packages using the rendering markup language involves inserting a set of markup tags in the rendering markup language to each package. The set of markup tags in the rendering markup language associated with each package defines the rendering properties for that package. The rendering properties define how a package may be displayed on the end device. The rendering properties associated with a package may include, but are not limited to, a display location for the package, a size of the package, color information associated with the package, alignment of the package, focus of the package, and font associated with the package. The display location specifies where the package is to be displayed on the end device relative to other packages. The size of the package specifies the amount of real estate on a display of the end device that the package should consume. The size of the package may correspond to a dimension associated with the package. Additionally, rendering properties associated with the one or more packages may specify an order in which the one or more packages are to be rendered. For example, if a video associated with a web page is encoded into a first package and an image associated with the web page is encoded into a second package, then the rendering properties may define that the first package needs to be rendered after the second package.

The set of markup tags in the rendering markup language for each package are defined based on the end device on which the package is rendered. Thus, a package may be associated with different sets of tags when the package is to be rendered on different end devices. To define the set of tags in the rendering markup language for each package, encoding engine 208 obtains information corresponding to the capabilities of the end device and thin client 204 as illustrated in FIG. 3. Thereafter, encoding engine 208 defines the set of tags for each package based on the capabilities of the end device and thin client 204. The capabilities of the end device that may be obtained may include, one or more of a configuration of the end device, display characteristics of the end device, connection bandwidth profiles associated with thin client 204, and usage profiles associated with thin client 204 as illustrated in FIG. 3. Further, the display characteristics of the end device may include, but are not limited to, resolution of the display, size of the display, display calibration, flicker associated with the display and user interaction capabilities of the display. The user interaction capabilities of a display may include whether a user can interact with the display using a touch screen, using a mouse, using a TV remote or using a keyboard.

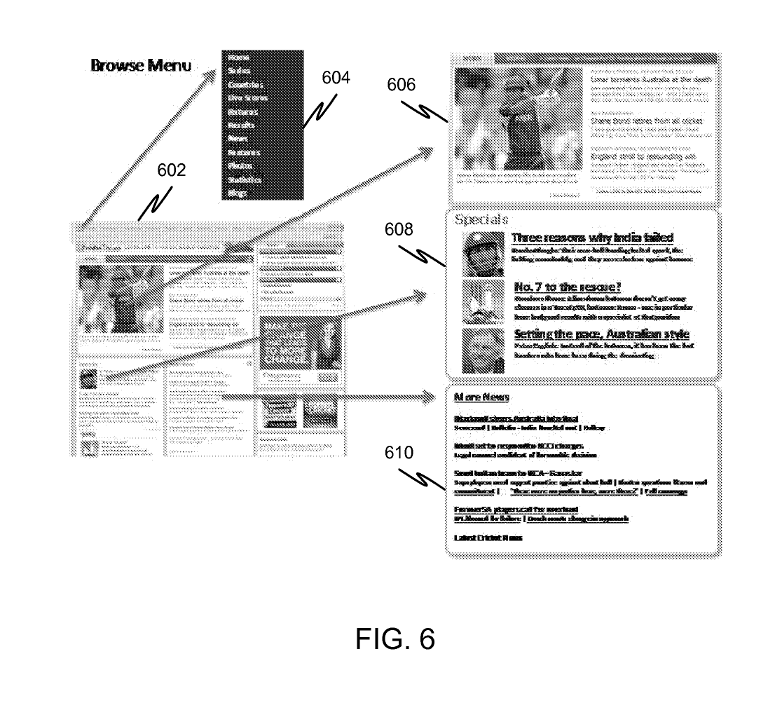

Encoding the one or more packages by encoding engine 208 may further include compressing the web content and/or scaling the web content based on the capabilities of the end device and thin client 204. For example, multimedia content associated with web content may be compressed and/or scaled based on the capabilities of an end device and the capabilities of a thin client communicably coupled to the end device. Compression reduces the data size of the web content thereby reducing a bandwidth required to transmit the web content to thin client 204 by encoding engine 208. Additionally, scaling the web content involves down-scaling or up-scaling the web content to meet the capabilities of the end device on which the web content is to be rendered. Scaling the web content may depend on the size of a display of the end device and a refresh rate associated with the display. Scaling of the web content may be performed based on pixel resolution, effective needed frames/second, as well as media encoding bit rates. Compression and scaling may be performed adaptively based on available bandwidth associated with thin client 204 and based on an acceptable latency associated with the end device. Further, encoding may also include converting navigational elements to browsing menus to simplify display on the end device as illustrated in FIG. 6.

On encoding the one or more packages by encoding engine 208, the one or more packages are transmitted to thin client 204 to be rendered on the end device. The order in which the one or more packages may be accessed by a user associated with thin client 204 is predicted by a pre-serving module 210 and accordingly a next potential package predicted by pre-serving module 210 is pre-served by pre-serving module 210 to thin client 204. This reduces the latency experienced by a user associated with the end device leading to an improved user experience. The process of predicting the next potential package may be achieved using any techniques known in the art without deviating from the scope of the invention.

When thin client 204 receives the one or more transmitted packages, thin client 204 decodes the one or more packages by interpreting the set of markup tags in the rendering markup language associated with each package of the one or more packages. As the plurality of markup tags in the native markup language associated with the web content are interpreted at encoding server 202 prior to transmission to thin client 204, thin client 204 only decodes the set of tags in the rendering markup language. Thus, each package is decoded and rendered on the end device in accordance with the rendering properties associated with each package. Additionally, the processing power required at thin client 204 is significantly reduced as thin client 204 only decodes the sets of tags in the rendering markup language, and not the plurality of markup tags in the native markup language. The number of tags in the rendering markup language that is to be interpreted by thin client 204 is lower than the plurality of tags in the native markup language. Hence by interpreting the plurality of tags in the native markup language at encoding server 202 and interpreting only the sets of tags in the rendering markup language at thin client 204, the number of tags to be interpreted by thin client 204 is significantly reduced.

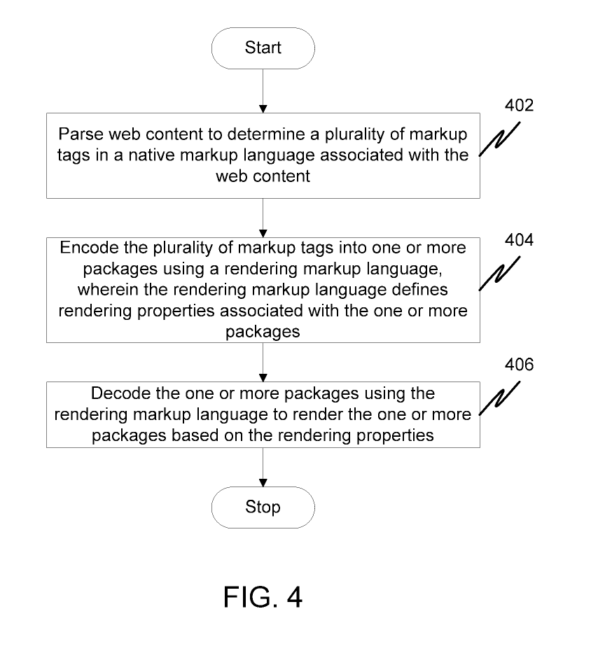

Moving on, FIG. 4 illustrates a flow diagram of a method of rendering web content in accordance with an embodiment of the invention. The web content may be received from one or more sources in a native markup language. The web content may include, but is not limited to, webpages and web feeds. At step 402, the web content is parsed to determine a plurality of markup tags in the native markup language. The native markup language may include, but is not limited to, Hypertext Markup Language (HTML), Extensible Hypertext Markup Language (XHTML), Extensible Markup Language (XML), Real Simple Syndication (RSS) and JavaScript Object Notation (JSON) languages.

On determining the plurality of markup tags in the native markup language, one or more of text content, multimedia content, user interaction elements, and navigational elements associated with the web content are determined based on the markup tags in the native markup language as explained in conjunction with FIG. 2. Further, a frame structure associated with a web page is broken to separate out the frames associated with the web page.

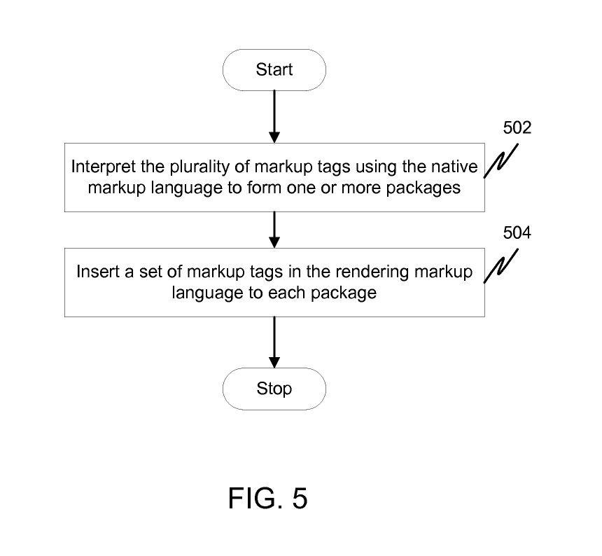

Thereafter, at step 404, the plurality of markup tags in the native markup language are encoded into one or more packages using a rendering markup language. The rendering markup language may be a graphical markup language and defines rendering properties associated with the one or more packages. Encoding the plurality of markup tags in the native markup language into the one or more packages includes inserting a set of markup tags in the rendering markup language to each package of the one or more packages. Encoding the plurality of markup tags into the one or more packages is further explained in conjunction with FIG. 5.

At step 406, the one or more packages are decoded using the rendering markup language to render the one or more packages based on the rendering properties associated with the one or more packages. The one or more packages are decoded by interpreting the set of markup tags in the rendering markup language associated with each package. This is explained in detail in conjunction with FIG. 2.

FIG. 5 illustrates a flow diagram of a method of encoding a plurality of markup tags into one or more packages in accordance with an embodiment of the invention. At step 502, the plurality of markup tags associated with the web content are interpreted using the native markup language to form the one or more packages. Creation of the one or more packages is explained in conjunction with FIG. 2. On interpreting the plurality of markup tags in the native markup language to form the one or more packages, a set of markup tags in the rendering markup language are inserted to each package at step 504. The set of markup tags in the rendering markup language associated with each package defines the rendering properties for that package. The rendering properties may define how a package is to be displayed on an end device. The rendering properties associated with a package may include, but are not limited to, a display location for the package, a size of the package, color information associated with the package, alignment of the package, focus of the package, and font associated with the package. The display location specifies where the package is to be displayed on the end device relative to other packages. The size of the package specifies the amount of real estate on a display of the end device that the package should consume. Additionally, rendering properties associated with the one or more packages may specify an order in which the one or more packages are to be rendered as explained in conjunction with FIG. 2.

The set of tags in the rendering markup language for each package are defined based on the end device on which the package is to be rendered. Thus, a package may be associated with different sets of tags when the package is to be rendered on different end devices. To define the set of tags in the rendering markup language for each package, information corresponding to the capabilities of the end device is obtained and the set of tags for a package is defined based on the capabilities of the end device. One or more of a configuration of the end device, display characteristics of the end device, connection bandwidth profiles associated with the end device, and usage profiles associated with the end device may be obtained. Further, the display characteristics of the end device may include, but are not limited to, resolution of the display, size of the display, display calibration, flicker associated with the display and user interaction capabilities of the display.

Encoding the one or more packages may further include compressing the web content and/or scaling the web content based on the capabilities of the end device. Compressing the web content reduces the data size of the web content thereby reducing a bandwidth required to transmit the web content to the end device. Additionally, scaling the web content involves size reduction and up-scaling. Scaling may be performed based on pixel resolution, effective needed frames/second, as well as media encoding bit rates. Compression and scaling may be performed adaptively based on available bandwidth associated with the end device and based on an acceptable latency. Further, encoding may also include converting navigational elements to browsing menus to simplify display on the end device as illustrated in FIG. 6.

On encoding the one or more packages, the one or more packages are transmitted to the end device to be rendered on the end device. The order in which the one or more packages may be accessed by a user of the end device may be predicted and accordingly a next potential package of the one or more packages may be pre-served to be decoded at the end device. This reduces the latency experienced by the user associated with the end device leading to an improved user experience. The process of predicting the next potential package may be achieved using any techniques known in the art without deviating from the scope of the invention.

In an example, if a web page includes an image and textual content corresponding to the image, the image and the textual content may be encoded as separate packages. If the web page is designed such that the image is hyperlinked to the textual content corresponding to the image, then the package including the textual content is predicted to be the next potential package that a user may access after the package corresponding to the image. Accordingly, the package corresponding to the textual content is pre-served to the end device along with the package corresponding to the image.

FIG. 6 illustrates an exemplary web page 602 encoded to be rendered on an end device display such as, a television screen in accordance with an embodiment of the invention. On receiving a request for web page 602 from a thin client associated with the television screen, an encoding server retrieves web page 602 in a native markup language from a web server. Thereafter, the encoding server parses web page 602 to determine a plurality of markup tags in the native markup language associated with web page 602. Subsequently, the plurality of markup tags in the native markup language are encoded by the encoding server into one or more packages such a package 604, a package 606, a package 608, and a package 610 using a rendering markup language. The processes of parsing and encoding the plurality of markup tags in the native markup language into the one or more packages using the rendering markup language is explained in conjunction with FIG. 2.

As illustrated in FIG. 6, a navigational element associated with web page 602 is encoded to a package 604 which represents a browsing menu. Similarly, frames of web page 602 are broken down into individual visual building blocks represented by package 606, package 608, and package 610. The plurality of markup tags in the native markup language corresponding to each frame of web page 602 are grouped together and interpreted by the encoding server using a rendering markup language to form package 606, package 608, and package 610. Each of package 606, package 608, and package 610 are associated with a set of markup tags in a rendering markup language as explained in conjunction with FIG. 2. The set of markup tags associated with a package define rendering properties for the package. The rendering properties define where and how a package is to be rendered and is based on the capabilities of the television screen. The capabilities of an end device which may influence the rendering properties of a package is explained in conjunction with FIG. 2. If package 606 is to be rendered on the television screen, package 606 may be encoded based on the screen size of the television screen, the resolution of the television screen, user interaction capabilities of the television screen, the configuration of the television screen, etc. Additionally, package 606 may be compressed or scaled accordingly to fit the television screen. Also, rendering properties associated with the package 606, package 608, and package 610 define an order in which package 606, package 608, and package 610 are to be rendered. As illustrated in FIG. 6, package 606 is rendered first, followed by package 608 followed by package 610. If more than one package can be rendered on the television screen at the same time, then the rendering properties specify a position for each package on the television screen.

Various embodiments of the invention provide method and systems for rendering web content based on capabilities of an end device on which the web content is to be rendered. To render the web content to an end device, the web content is broken down into constituent elements and interpreted at an encoding server to form one or more packages. The one or more packages represent visual building blocks corresponding to portions of the web page. These packages are then transmitted to an end device for rendering based on the capabilities of the end device. The visual building blocks corresponding to the packages are rebuilt at the end device to obtain the web content. Since the constituent elements of the web content are interpreted at the encoding server before serving the web content to the end device, the processing power required by the end device is greatly reduced. The end device only needs to interpret markup tags in the rendering markup language associated with each package rather that each markup tag associated with the raw web content. Additionally, as a result of encoding by the encoding server, the web content is compressed and/or sized according to the capabilities of the end device to ensure optimal rendering at the end device. Further, the bandwidth required to transmit the packages is also reduced. The method and system disclosed herein is adaptable for end devices having varied configurations and display properties as the configurations and display properties of the end devices are taken into consideration when encoding the plurality of markup tags into one or packages.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of rendering web content, the method comprising:
parsing the web content to determine a plurality of markup tags in a native markup language associated with the web content;
encoding the plurality of markup tags into at least one package using a rendering markup language, wherein the rendering markup language defines rendering properties associated with the at least one package; and
decoding the at least one package using the rendering markup language to render the at least one package based on the rendering properties.

2. The method of claim 1, wherein the web content comprises at least one of webpages and web feeds.

3. The method of claim 1, wherein parsing the web content comprises determining at least one of text content, multimedia content, user interaction elements, and navigational elements associated with the web content.

4. The method of claim 1, wherein encoding the plurality of markup tags into at least one package comprises:
interpreting the plurality of markup tags using the native markup language to form the at least one package; and
inserting a set of markup tags in the rendering markup language to each package of the at least one package.

5. The method of claim 1, wherein encoding the plurality of markup tags comprises at least one of compressing and scaling the web content associated with the plurality of markup tags in the native markup language.

6. The method of claim 4, wherein decoding a package of the at least one package comprises interpreting the set of markup tags in the rendering markup language associated with each package of the at least one package.

7. The method of claim 1 further comprising obtaining at least one of a configuration of an end device, display characteristics of the end device, connection bandwidth profiles associated with the end device, and usage profiles associated with the end device.

8. The method of claim 7, wherein the display characteristics comprise at least one of resolution of the display, size of the display, display calibration, flicker associated with the display and user interaction capabilities of the display.

9. The method of claim 7, wherein the rendering properties are defined based on at least one of the configuration of the end device, the display characteristics of the end device, the connection bandwidth profiles associated with the end device, and the usage profiles associated with the end device.

10. The method of claim 1, wherein rendering properties associated with a package of the at least one package comprises at least one of a display location of the package, size of the package, color information associated with the package, alignment of the package, focus of the package, and font associated with the package.

11. The method of claim 1, wherein the rendering properties associated with the at least one package comprises a rendering order of the at least one package.

12. The method of claim 1 further comprising pre-serving a next potential package of the at least one package to be decoded.

13. A system for rendering web content on an end device, the system comprising:
an encoding server comprising:
a parser for parsing the web content to determine a plurality of markup tags in a native markup language associated with the web content; and
an encoding engine for encoding the plurality of markup tags into at least one package using a rendering markup language, wherein the rendering markup language defines rendering properties associated with the at least one package; and
a thin client configured to decode the at least one package using the rendering markup language to render the at least one package on the end device based on the rendering properties.

14. The system of claim 13, wherein the parser is configured to determine at least one of text content, multimedia content, user interaction elements, and navigational elements associated with the web content.

15. The system of claim 13, wherein for encoding the plurality of markup tags into at least one package, the encoding engine is configured to:
interpret the plurality of markup tags using the native markup language to form the at least one package; and
insert a set of markup tags in the rendering markup language to each package of the at least one package.

16. The system of claim 13, wherein for encoding the plurality of markup tags into at least one package, the encoding engine is configured to perform at least one of compression and scaling the web content associated with the plurality of markup tags in the native markup language.

17. The system of claim 16, wherein encoding the plurality of markup tags into the at least one package reduces a data size associated with the web content thereby reducing a bandwidth required to transmit the web content to the thin client by the encoding server.

18. The system of claim 13, wherein the encoding server further comprises a pre-serving module for pre-serving a next potential package of the at least one package to be decoded by the thin client.

19. The system of claim 13, wherein for decoding the at least one package, the thin client is configured to interpret the set of markup tags in the rendering markup language associated with each package of the at least one package.

20. The system of claim 13, wherein the encoding engine obtains at least one of a configuration of the end device, display characteristics of the end device, connection bandwidth profiles associated with the thin client, and usage profiles associated with the thin client from the thin client.

21. The system of claim 20, wherein the encoding engine is configured to define rendering properties for each package of the at least one package based on at least one of the configuration of the end device, the display characteristics of the end device, the connection bandwidth profiles associated with the thin client, and the usage profiles associated with the thin client.

22. The system of claim 13, wherein the rendering properties associated with a package of the at least one package comprises at least one of a display location of the package, and size of the package, color information associated with the package, alignment of the package, focus of the package, and font associated with the package.

23. The system of claim 13, wherein the rendering properties associated with the at least one package comprises a rendering order of the at least one package.
